(19) United States
(12) Patent Application Publication
(10) Pub. No.: US 2019/0111937 A1
(43) Pub. Date: Apr. 18, 2019

(54) VEHICLE CONTROL SYSTEM WITH DRIVER PROFILE

(71) Applicant: Magna Electronics Inc., Auburn Hills, MI (US)

(72) Inventor: Naveen Halesha, Rochester Hills, MI (US)

(21) Appl. No.: 16/155,918

(22) Filed: Oct. 10, 2018

Related U.S. Application Data
(60) Provisional application No. 62/571,449, filed on Oct. 12, 2017.

(51) Int. Cl. B60W 50/00; G06F 17/30; B60W 10/06; B60W 10/30; B60W 30/14; B60W 30/12; B60W 50/14; B60W 30/09

(52) U.S. Cl. CPC B60W 50/0098; G06F 17/30876; B60W 10/06; B60W 10/30; G06K 9/00818; B60W 30/12; B60W 50/14; B60W 30/09; B60W 2540/28; B60W 30/146

(57) ABSTRACT

A control system for a vehicle includes a control that, when a particular driver is in the vehicle, receives an input indicative of that particular driver and associates the particular driver with a driver profile. An engine control module is disposed in the vehicle and is provided with an output of the control. The engine control module, responsive to the provided output, regulates speed that the vehicle can be driven by that particular driver. The provided output is dependent on the driver profile for that particular driver. Responsive to the provided output, at least one function of a vehicle accessory is controlled. The vehicle accessory may be an accessory selected from the group consisting of (i) an infotainment module, (ii) a telematics system, (iii) an image vision system and (iv) a forward viewing camera module.

### CROSS REFERENCE TO RELATED APPLICATION

The present application claims the filing benefits of U.S. provisional application Ser. No. 62/571,449, filed Oct. 12, 2017, which is hereby incorporated herein by reference in its entirety.

### FIELD OF THE INVENTION

The present invention relates generally to a control system for a vehicle and, more particularly, to a vehicle control system that controls one or more accessories or systems of a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driving assistance system or control system for a vehicle that, responsive to a driver profile for a particular driver, controls or limits performance of various vehicle functions or systems. The body control module of the vehicle may communicate a driver profile ID to the engine control module to regulate the vehicle maximum vehicle speed and/or acceleration when that identified driver is driving the vehicle. The body control module may communicate the driver profile ID to a front camera module, which may adjust or control an adaptive cruise control system or traffic sign recognition or lane departure warning or automatic emergency braking or the like (where the image processor and control of the camera module adjusts control of these functions responsive to the driver profile ID and processing of image data captured by the forward viewing camera). The body control module may communicate the driver profile ID to an infotainment module, which may regulate the maximum volume of the vehicle radio or the like. The body control module may communicate the driver profile ID to a telematics system of the vehicle, which may regulate connectivity with the system or access to various system functions. The body control module may communicate the driver profile ID to an image vision system, which may enable or disable various display features.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a control system in accordance with the present invention; and

FIG. 2 is a block diagram of the control system of the present invention.

### DESCRIPTION OF THE PREFERRED EMBODIMENTS

A vehicle control system and/or driving assist system operates to control one or more accessories or systems of functions of a vehicle responsive to a user profile and one or more other inputs or triggers. The system may include a camera that captures image data representative of a view or scene exterior of the vehicle and may process the captured image data to display images and to detect objects at or near the vehicle and in the predicted path of the vehicle, such as to assist in maneuvering the vehicle.

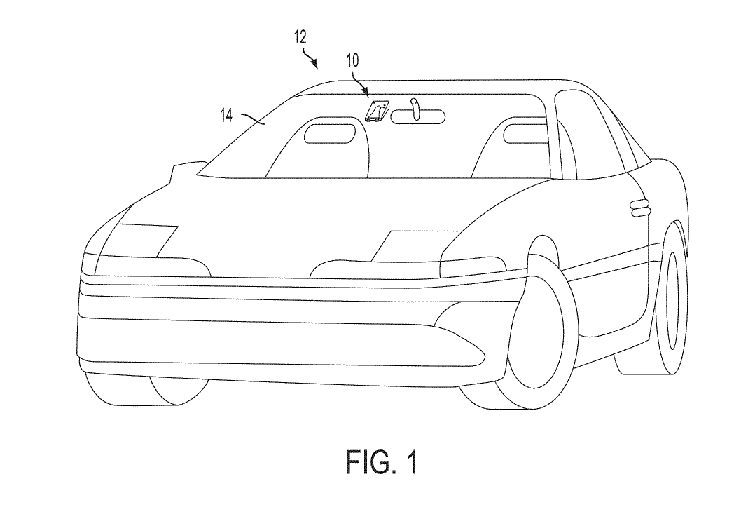

Referring now to the drawings and the illustrative embodiments depicted therein, the control system 10 for a vehicle 12 may include or be responsive to at least one exterior viewing imaging sensor or camera, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. Optionally, the forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 10 includes a control or electronic control unit (ECU) or processor that is operable to process image data captured by the camera or cameras and may detect objects or the like and/or provide displayed images at a display device for viewing by the driver of the vehicle. The data transfer or signal communication from the camera to the ECU may comprise any suitable data or communication link, such as a vehicle network bus or the like of the equipped vehicle.

The control system of the present invention controls systems or functions of the vehicle or limits performance or operation of systems or functions of the vehicle responsive at least in part to a driver profile for the driver of the vehicle. The driver profile is created for the individual driver and the system may recognize that driver and associate the stored driver profile with that driver before ignition start of the vehicle. For example, the control system may identify the particular driver via a finger print scan or other biometric data of the person sitting in the driver's seat of the vehicle.

The control system of the present invention is suitable for use with young drivers, such as permitted drivers and newly licensed drivers, so that the vehicle is limited in its performance and other functions when that young or newly licensed driver is driving the vehicle. The driver profile may be set up by an administrator of the system, such as the vehicle owner or parent of the young or newly licensed driver, whereby, after the driver profile is entered into the system, any time that driver drives the vehicle, the control system will control or limit various functions according to the driver profile. Optionally, such a control system and driver profile may find use in rental car applications (to avoid excessively harmful driving of the rental car by a person renting it) or suspended license drivers (for when the driver initially becomes unsuspended so that the driving behavior is controlled to avoid further suspension). The driver profile may be stored in memory of the vehicle, or may be provided via wireless communication from a remote server or device.

When the driver profile function is activated, the control may control or adjust or limit the engine's maximum RPMs, the maximum vehicle speed, the minimum following distance behind another vehicle, a lane keeping function, radio volume and/or telematics system functions and/or the like. The control may adjust or control or limit functions of the vehicle further in response to various inputs, such as the current geographical location of the vehicle, and may control or adjust traffic sign recognition function, traffic alerts and/or vehicle tracking.

With the Vehicle Database (DBC) made available to the Body Control Module (BCM), the BCM could setup the driver profile. Based on the profile, the BCM could provide feedback to the Engine Control Module (ECM) to control the engine RPM and/or vehicle speed.

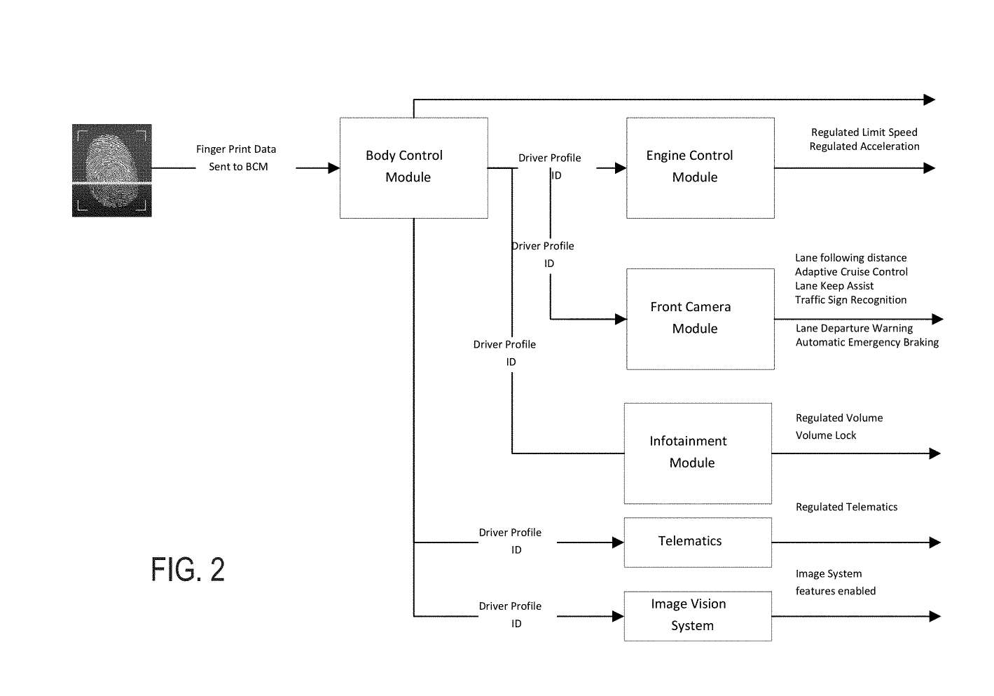

Thus, the control system of the present invention (such as shown in FIG. 2) may receive finger print data (or other biometric data) from the person about to drive the vehicle, and that data may be sent to the BCM with security. The BCM stores the finger print data and may set up a driver profile with age criteria and save the profile with an identification (such as the person's name or other identifier of that driver). The driver profile is configurable by the end user.

The driver profile ID is accessed by the engine control module. An infotainment module and front camera module may adjust or control or regulate various vehicle systems (see FIG. 2) based on the age of the driver in accordance with the driver profile. The driver profile may also control the comfort amenities of the vehicle such as seat position, HVAC settings, mirror adjustments, steering column setting or adjustment, control pedals and/or the like.

A surround view camera ECU may enable image vision safety features by default such as trajectory, ultrasonic overlays and/or the like. The driver profile may also be used to control a telematics system of the vehicle, such as to limit or prevent Bluetooth connection and/or WiFi connections except for in an emergency calling situation.

As shown in FIG. 2, the body control module of the vehicle receives the finger print data (or other biometric data or identification of a particular driver associated with a particular driver profile) and may communicate the driver profile ID or parameters to the engine control module to regulate the vehicle maximum vehicle speed and/or acceleration when that identified driver is driving the vehicle. The body control module may also or otherwise communicate the driver profile ID to the front camera module, which may adjust or control an adaptive cruise control system or traffic sign recognition or lane departure warning or automatic emergency braking or the like (where the image processor and control of the camera module adjusts control of these functions responsive to the driver profile ID and processing of image data captured by the forward viewing camera). The body control module may also or otherwise communicate the driver profile ID to the infotainment module, which may regulate the maximum volume of the vehicle radio or the like. The body control module may also or otherwise communicate the driver profile ID to a telematics system of the vehicle, which may regulate connectivity with the system or access to various system functions. The body control module may also or otherwise communicate the driver profile ID to an image vision system, which may enable or disable various display features.

The system of the present invention thus provides enhanced safety of young or newly licensed drivers. The system may also monitor the driver's performance, and may determine if further controls may be appropriate or necessary, particularly if the vehicle is GPS equipped and the system can determine where the vehicle is during various detected driving maneuvers and activities. The system of the present invention thus may provide peace of mind to parents/guardians and may assist law enforcement personnel. The system may also assist or protect other drivers on the road. Because the system controls or limits performance of a vehicle and limits distractions to the newly licensed driver, the system may also provide a cost savings for insurance companies, since a newly licensed driver is less likely to be distracted or to drive dangerously when the control system is operating as described above.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ™ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 8,256,821; 7,480,149; 6,824,281 and/or 6,690,268, and/or U.S. Publication Nos. US-2015-0327398; US-2015-0015713; US-2014-0160284; US-2014-0226012 and/or US-2009-0295181, which are all hereby incorporated herein by reference in their entireties.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication No. WO 2011/090484 and/or U.S. Publication Nos. US-2017-0276788; US-2017-0254873; US-2017-0222311 and/or US-2010-0245066, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, said vehicular control system comprising:
a control disposed in a vehicle equipped with said vehicular control system;
wherein said control comprises a data processor;
wherein, with a particular driver in the equipped vehicle, said control receives an input indicative of that particular driver, and wherein said control associates the particular driver with a driver profile;
an engine control module disposed in the equipped vehicle;
wherein said control provides an output to said engine control module;
wherein the output of said control is dependent on the driver profile associated with the particular driver of the equipped vehicle;
wherein said engine control module, responsive to the provided output, regulates speed that the equipped vehicle can be driven by that particular driver;
wherein, responsive to the output of said control, at least one function of a vehicle accessory is controlled; and
wherein the vehicle accessory comprises an accessory selected from the group consisting of (i) an infotainment module wherein the at least one function comprises a maximum volume, (ii) a telematics system wherein the at least one function comprises wireless connectivity with the telematics system, (iii) an image vision system wherein the at least one function comprises display functions, and (iv) a forward viewing camera module wherein the at least one function comprises a driving assist system of the equipped vehicle.

2. The vehicular control system of claim 1, wherein the vehicle accessory comprises a forward viewing camera module, and wherein the at least one function comprises a driving assist system of the equipped vehicle.

3. The vehicular control system of claim 2, wherein the driving assist system comprises a system selected from the group consisting of (a) an adaptive cruise control system, (b) a lane keep assist function, (c) a traffic sign recognition system, (d) a lane departure warning system, and (e) an automatic emergency braking system.

4. The vehicular control system of claim 1, wherein the vehicle accessory comprises an infotainment module, and wherein the at least one function comprises a maximum volume.

5. The vehicular control system of claim 1, wherein the vehicle accessory comprises a telematics system, and wherein the at least one function comprises wireless connectivity with the telematics system.

6. The vehicular control system of claim 1, wherein the vehicle accessory comprises an image vision system, and wherein the at least one function comprises display functions.

7. The vehicular control system of claim 1, wherein the engine control module, responsive to the provided output, regulates the maximum acceleration that the equipped vehicle can be driven by that particular driver.

8. The vehicular control system of claim 1, wherein said control is part of a body control module of the equipped vehicle.

9. The vehicular control system of claim 1, wherein the driver profile comprises preferred settings for that particular driver for at least one selected from the group consisting of (i) seat position settings, (ii) HVAC settings, (iii) mirror position settings, (iv) steering column position settings.

10. The vehicular control system of claim 1, wherein said engine control module, responsive to the provided output, regulates maximum speed that the equipped vehicle can be driven by that particular driver.

11. The vehicular control system of claim 1, wherein the driver profile is stored in memory associated with said control.

12. The vehicular control system of claim 1, wherein the driver profile is provided via wireless communication from a remote server.

13. A vehicular control system, said vehicular control system comprising:
a control disposed in a vehicle equipped with said vehicular control system;
wherein said control comprises a data processor;
wherein, with a particular driver in the equipped vehicle, said control receives an input indicative of that particular driver, and wherein said control associates the particular driver with a driver profile;
wherein the driver profile is stored in memory associated with said control;
an engine control module disposed in the equipped vehicle;
wherein said control provides an output to said engine control module;
wherein the output of said control is dependent on the driver profile associated with the particular driver of the equipped vehicle;
wherein said engine control module, responsive to the provided output, regulates maximum speed that the equipped vehicle can be driven by that particular driver;
wherein the engine control module, responsive to the provided output, regulates the maximum acceleration that the equipped vehicle can be driven by that particular driver;
wherein, responsive to the output of said control, at least one function of a vehicle accessory is controlled; and
wherein the vehicle accessory comprises an accessory selected from the group consisting of (i) an image vision system wherein the at least one function comprises display functions and (ii) a forward viewing camera module wherein the at least one function comprises a driving assist system of the equipped vehicle.

14. The vehicular control system of claim 13, wherein the vehicle accessory comprises a forward viewing camera module, and wherein the at least one function comprises a driving assist system of the equipped vehicle.

15. The vehicular control system of claim 14, wherein the driving assist system comprises a system selected from the group consisting of (a) an adaptive cruise control system, (b) a lane keep assist function, (c) a traffic sign recognition system, (d) a lane departure warning system, and (e) an automatic emergency braking system.

16. The vehicular control system of claim 13, wherein the vehicle accessory comprises an image vision system, and wherein the at least one function comprises display functions.

17. The vehicular control system of claim 13, wherein said control is part of a body control module of the equipped vehicle.

18. A vehicular control system, said vehicular control system comprising:
a control disposed in a vehicle equipped with said vehicular control system;
wherein said control comprises a data processor;
wherein, with a particular driver in the equipped vehicle, said control receives an input indicative of that particular driver, and wherein said control associates the particular driver with a driver profile;
wherein the driver profile is stored in memory associated with said control;
an engine control module disposed in the equipped vehicle;
wherein said control provides an output to said engine control module;
wherein the output of said control is dependent on the driver profile associated with the particular driver of the equipped vehicle;
wherein said engine control module, responsive to the provided output, regulates maximum speed that the equipped vehicle can be driven by that particular driver;
wherein the engine control module, responsive to the provided output, regulates the maximum acceleration that the equipped vehicle can be driven by that particular driver;
wherein, responsive to the output of said control, at least one function of a vehicle accessory is controlled; and
wherein the vehicle accessory comprises an accessory selected from the group consisting of (i) an infotainment module wherein the at least one function comprises a maximum volume and (ii) a telematics system wherein the at least one function comprises wireless connectivity with the telematics system.

19. The vehicular control system of claim 18, wherein the vehicle accessory comprises an infotainment module, and wherein the at least one function comprises a maximum volume.

20. The vehicular control system of claim 18, wherein the vehicle accessory comprises a telematics system, and wherein the at least one function comprises wireless connectivity with the telematics system.
